(19) United States
(12) Patent Application Publication
(10) Pub. No.: US 2012/0231135 A1
(43) Pub. Date: Sep. 13, 2012

(54) VARIABLE-HEIGHT INJECTOR BREWHEAD FOR AIRCRAFT BEVERAGE MAKER

(76) Inventor: Rachel Kuniyoshi Cabe, Centreville, VA (US)

(21) Appl. No.: 13/417,511

(22) Filed: Mar. 12, 2012

Related U.S. Application Data
(60) Provisional application No. 61/451,688, filed on Mar. 11, 2011.

(51) Int. Cl. A47J 31/46; A23F 5/26

(52) U.S. Cl. 426/433; 99/280

(57) ABSTRACT

Embodiments of the present invention provide improved injector heads from use in coffee makers, and particularly for coffee makers used on board passenger transport vehicles.

This application claims the benefit of U.S. Provisional Application Ser. No. 61/451,688, filed Mar. 11, 2011 titled “Variable Height Injector Brewhead for Aircraft Coffee Maker,” the entire contents of which are hereby incorporated by reference.

### FIELD OF THE INVENTION

Embodiments of the present invention relate generally to aircraft beverage makers, and specifically coffee makers, and specifically, to coffee makers for use on board passenger transport vehicles. Specific embodiments are designed for particular use in aircraft galleys. Various embodiments provide improvements to injector heads that allow for variable heights, which can provide increased brewing efficiencies.

### BACKGROUND

One convenient advance in coffee maker brewing has been pre-packaged coffee grounds, such as grounds provided in pillow packs, capsules, pods, or other packages. “Pillow packs” are coffee grounds encased in a paper filter, which prevents the user from having to load a separate filter and handle potentially messy coffee grounds. These pillow packs may be used in traditional coffee and espresso makers (e.g., for residential and commercial use), as well as for beverage makers for use on-board passenger transport vehicles. Loose coffee grounds can be a particular nuisance for food service on-board passenger transport vehicles, such as aircraft, where working and storage space in the galley is relatively limited and where messes can be more difficult to clean. Accordingly, pillow packs and other pre-packaged coffee grounds are being more commonly used.

In use, the pillow pack (or capsule or pod, if used) is placed in the brew basket and water is delivered as usual. (However, for certain capsules and pods, specific interior features of the beverage maker are designed that allow access to the coffee grounds inside the pod or capsule.)

Different types of pillow packs have varying levels of permeability to water, thus directly affecting the ability a coffee maker to brew acceptable coffee. Drip-type coffee brewing systems have suffered poor performance with certain types of pillow packs, as the dripping water typically drips onto, then runs off of, the filter paper of the pack. This results in very weak and unflavorful coffee.

One solution has been to attempt to force water into the pillow pack. Previous coffee maker designs have used an injection method of brewing by compressing the pillow pack in a small, fixed, and sealed space against a water outlet supplied by a pressurized hot water tank. However, compressing the pillow pack in a small space, along with subjecting it to highly turbulent, possibly overheated water and steam, greatly increases the chances of the filter paper rupturing. A ruptured pillow pack creates unsanitary conditions and crew inconvenience, and the sealed brew chamber is a potential safety hazard because it creates a temporary pocket of highly pressurized steam that could violently escape if a flight attendant opened the brew chamber very quickly. Additionally, brewing a pillow pack in a compressed space does not allow it to fully absorb aromatic compounds that are released during brew; the resultant brew will have little aroma, a key trigger for the perception of flavor.

Accordingly, it is desirable to provide improved beverage makers that can effectively and safely brew pre-packaged pillow packs and other forms of pre-packaged coffee grounds.

### BRIEF SUMMARY

Embodiments of the present invention provide improved injector heads for coffee makers, particularly coffee makers that are mounted on board passenger transport vehicles. Although the coffee makers described herein find particular application on board passenger transport vehicles, it should be understood that they may be used in connection with any type of coffee maker or espresso maker, including residential, commercial, or any other option.

Specific embodiments provide injector heads that are designed to allow the pillow pack to expand, while still applying sufficient injection of water in order to brew aromatic coffee.

Other embodiments provide injector heads that are moveable in order to accommodate variously sized pillow packs, as well as expansion of the pillow pack during brewing.

### BRIEF DESCRIPTION OF THE DRAWINGS

FIG. 1 shows a schematic view of a beverage maker injector head in a first lowered position.

FIG. 2 shows a schematic view of a beverage maker injector head in a second raised position.

FIG. 3 shows a side plan view of a brew piston in a floating position.

FIG. 4 shows a perspective view of the brew piston of FIG. 3.

FIG. 5 shows a side plan view of a brew piston in a lowered position.

FIG. 6 shows a perspective view of the brew piston of FIG. 5.

FIG. 7 shows a side plan view of a brew piston in a lifted position.

FIG. 8 shows a perspective view of the brew piston of FIG. 7.

FIG. 9 shows a brew piston in relation to a brew basket in a floating/raised position.

FIG. 11 shows a brew piston in relation to a brew basket in the lowered position.

FIG. 11 shows an alternate embodiment of a brew piston movement.

### DETAILED DESCRIPTION

Embodiments of the present invention provide beverage makers, such as coffee makers or espresso makers or other appliances, that use a variable-height injector head. Although designed for use on-board passenger transport vehicles such as aircraft, the embodiments described herein may be used in connection with any type of coffee or espresso maker, including residential and/or commercial beverage makers.

One of the features of this invention is that is uses a more gentle method of infusing the pillow pack with water. The actuating infusion brewhead allows the pillow pack to expand as the water fills it. This reduces the chance of pillow pack rupture, and also eliminates the need for a pressurized water tank.

A further feature is that the embodiments described herein do not require a sealed brew chamber. Leaving the brew chamber open to ambient atmosphere during brewing means that small amounts of steam and pressure can escape safely during the brew cycle, eliminating the potential for a high temperature, pressurized steam pocket to form.

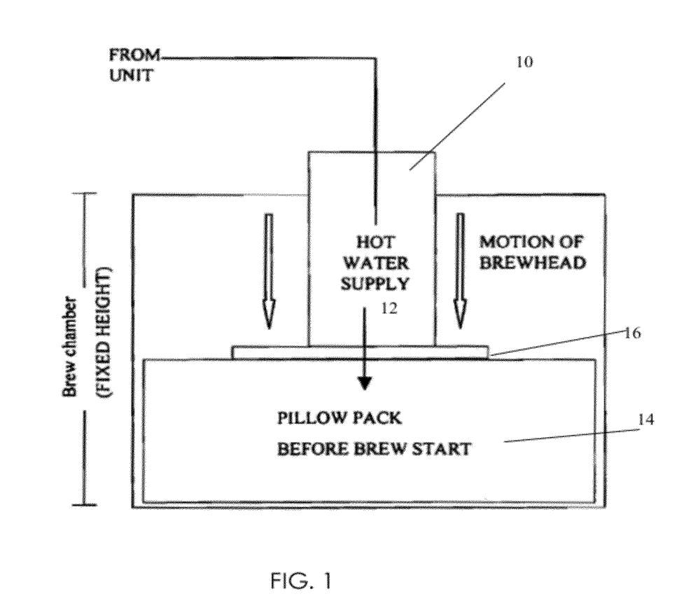

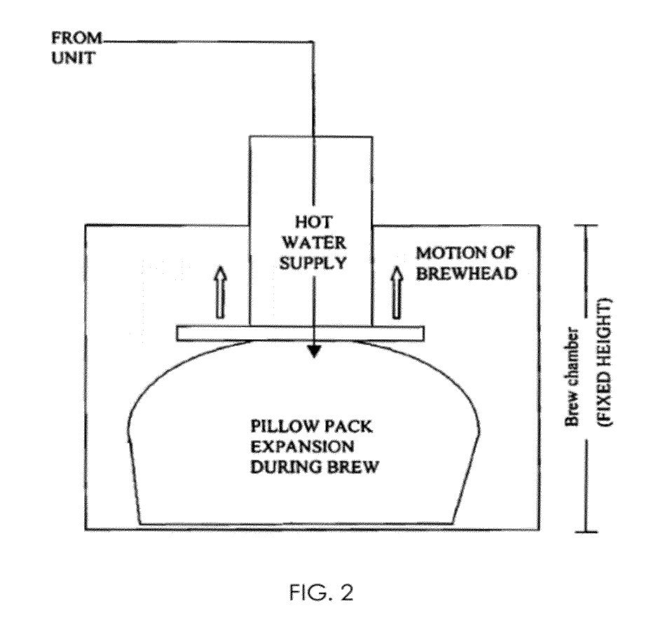

As shown in FIGS. 1 and 2, there is provided an actuating brewhead 10 that moves the supply point 12 of hot water directly onto the top surface of the pillow pack 14, infusing it with water during the brew cycle. During the brew cycle, the pillow pack 14 will expand as it fills with hot water due to both water pressure and offgassing of steam and aromatic compounds from the coffee grounds. In a specific embodiment, the actuating brewhead 10 will have a weight and shape that optimizes the contact point or surface 16 between the brewhead 10 and the pillow pack 14, but will not be so heavy enough as to resist the pillow pack 14 expansion. The pillow pack is thus able to push the brewhead 10 up to its maximum allowable height, giving the coffee grounds ample room to mix thoroughly with the incoming water and retain some aromatic compounds, resulting in a more robust brew flavor.

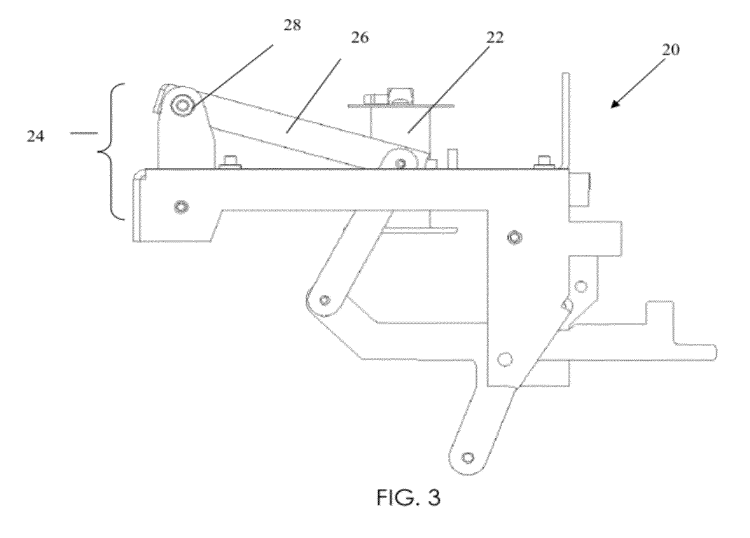

In a particular embodiment, as shown in FIGS. 3-11, an indicator system 20 indicates when movement of the brewhead 10 is necessary. Indicator system may be a mechanical cooperation of parts, guided by gravity and movement, or it may be an electrically-based system or any other appropriate indicator system that indicates that the pillow pack is expanding and that movement of brewhead is necessary. In a particular embodiment, indicator system 20 may include a brew piston 22 secured to the beverage maker via one or more attachment points 24. In a particular embodiment, the attachment point(s) may be provided by a lever arm 26 and a pivot potion 28, but it should be understood that any appropriate attachment point(s) 24 may be used and is/are considered within the scope of this invention. For example, alternate attachment points may include but are not limited to a pulley system, a magnetic system, a spring loaded system, or any other appropriate system that can cause appropriate raising and lowering of brewhead.

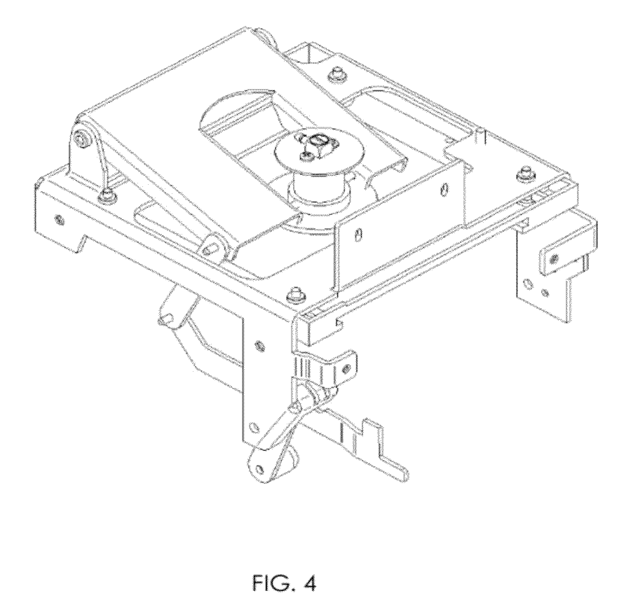

As shown in FIGS. 3 and 4, the brewhead 10 is initially allowed to free float, such that the weight of the brewhead 10 causes it to lower into the chamber until contacting a pillow pack or other coffee ground packaging structure. FIGS. 3 and 4 illustrate the brew piston 22 is a floating state, meaning that it is not fully raised or lowered.

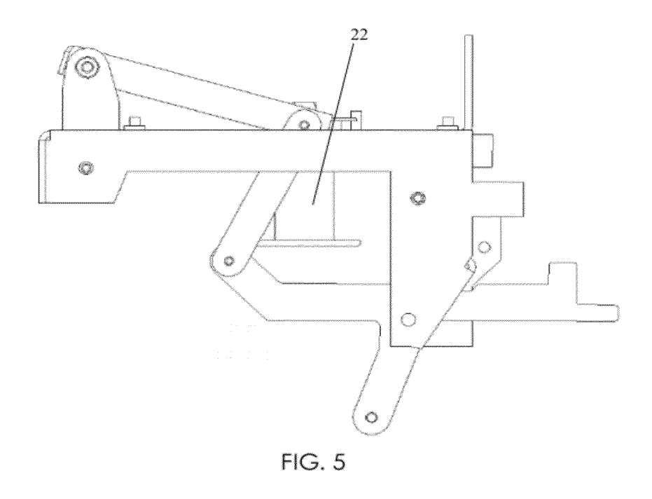

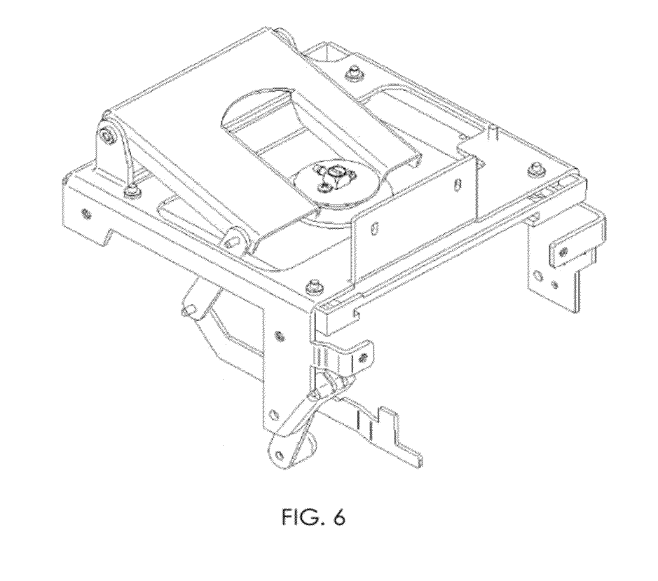

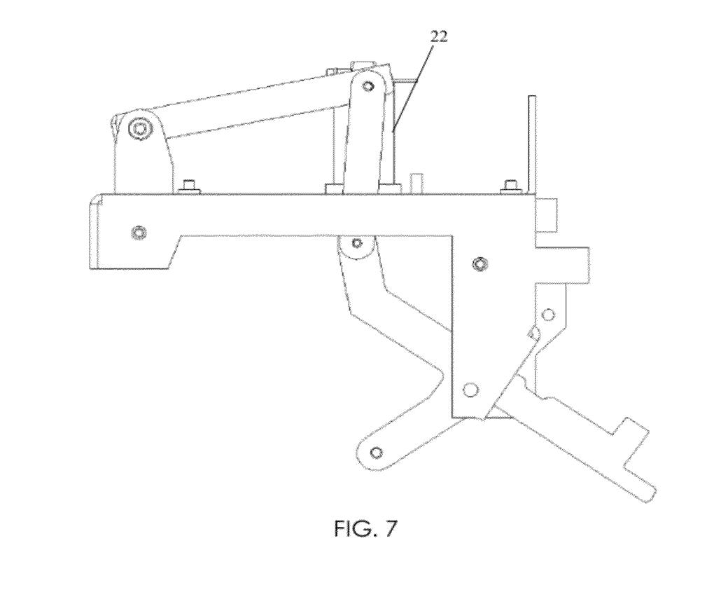

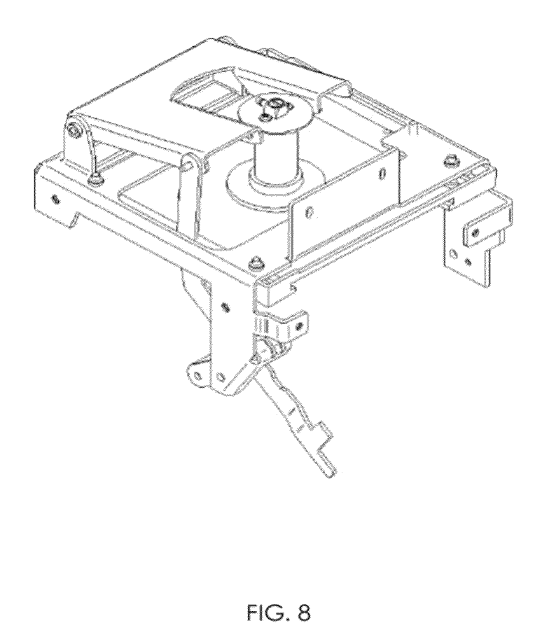

An example of brew piston 22 in a lowered position is shown in FIGS. 5-6. In this position, brewhead is allowed to hover over and contact a pillow pack without applying strong pressure thereto, but to be in a contacting position, such that a contact point 16 between pillow pack 14 and brewhead 10 is maintained. The weight of the brewhead 10 is not, however, so heavy as to maintain a constant pressure against the pillow pack upon return pressure from the pillow pack as it is filled with water. As such, expansion of the pillow pack 14 in a upward manner allows the brew piston 22 to rise, which causes the brewhead 10 to rise. As example of a brew piston in the lifted position is illustrated by FIGS. 7-8. Brewhead 10 still maintains sufficient contact with the pillow pack 14 that the water and steam being injected from the head 10 is infused into the pack 14 and not allowed to roll off.

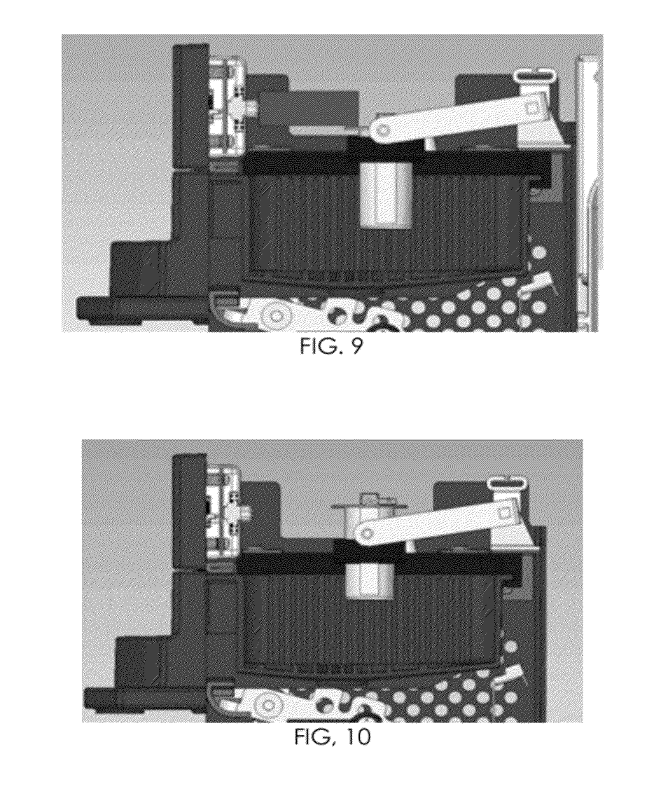

In one embodiment, one or more levers or arms 26 may be secured to brewhead 10, as shown in FIGS. 3-8. Movement of brew piston 22 causes movement of levers/arms 26 in order to cause movement of the brewhead 10. FIGS. 9 and 10 illustrate alternate connections between brewhead, brew piston, and levers/arms.

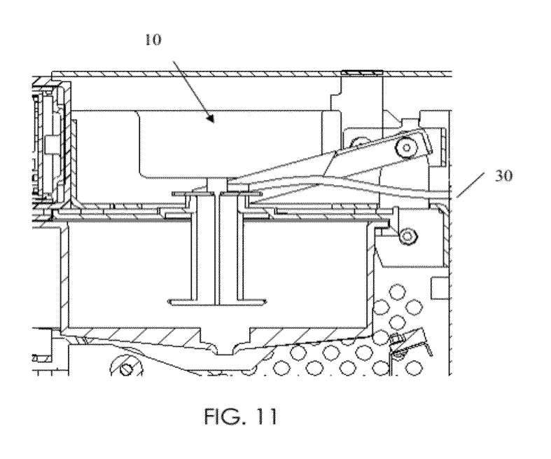

FIG. 11 illustrates that a tube 30 may provide fluid communication between the water supply part 12 of the brewhead 10 and the water tank/heating system of the beverage maker. Tube 30 may be flexible, such that it moves up and down with the variable height movement of the brewhead 10.

In an alternate embodiment, rather than a mechanical indicator that the brew piston should move upward to allow expansion of the pillow pack, the mechanism for moving the brewhead 10 may be electrical. For example, there may be a sensor or an eye or a laser level detector associated with the brewhead 10 that indicates to a control system when the brewhead 10 is in contact with the pillow pack 14. When the pillow pack expands, the sensor may indicate to the control system that the brew piston should be raised in one or more increments in order to allow proper infusion.

Changes and modifications, additions and deletions may be made to the structures and methods recited above and shown in the drawings without departing from the scope or spirit of the invention and the following claims.

What is claimed is:

1. A variable-height injector brewhead for a beverage maker infusing water into pre-packaged coffee grounds, comprising:
(a) a brewhead comprising a water supply point and a contact point;
(b) a brew piston configured to detect a position of a pre-package coffee ground in the brewhead and to cause variable height movement of the brewhead based on an expansion size of the pre-packaged coffee grounds; and
(c) an attachment point securing the brewhead to the beverage maker, the attachment point allowing variable movement of the brewhead with respect to the beverage maker upon a change in size of the pre-packaged coffee grounds.

2. The variable-height injector brewhead of claim 1, wherein when the package containing the pre-packaged coffee grounds expands, the variable height brewhead is allowed to raise.

3. The variable-height injector brewhead of claim 1, wherein the variable height brewhead can accommodate variously sized pre-packaged coffee grounds.

4. The variable-height injector brewhead of claim 1, wherein the attachment point comprises a lever arm and a pivot point.

5. The variable-height injector brewhead of claim 1, wherein the pre-packaged coffee ground comprise a pillow pack.

6. The variable-height injector brewhead of claim 1, wherein the beverage maker in designed for use on-board a passenger transport vehicle.

7. The variable-height injector brewhead of claim 1, wherein the beverage maker is installed on an aircraft.

8. A method for brewing coffee provided in a pre-packaged configuration, comprising;
(a) providing a beverage maker with a variable-height injector brewhead;
(b) positioning a package of the pre-packaged coffee in a brew basket of the beverage maker such that the variable-height injector brewhead contacts the package;
(c) causing the beverage maker to inject water into the package such that the package expands and the variable-height injector brewhead is correspondingly raised to allow an expansion area for the package.
